(19) United States
(12) Patent Application Publication
(10) Pub. No.: US 2014/0215392 A1
(43) Pub. Date: Jul. 31, 2014

(54) CONNECTIONS IDENTIFICATION

(71) Applicant: INTERNATIONAL BUSINESS MACHINES CORPORATION, Armonk, NY (US)

(72) Inventors: Lisa Seacat DeLuca, San Francisco, CA (US); Xue Jiang, Littleton, MA (US); Asima Silva, Westford, MA (US)

(73) Assignee: International Business Machines Corporation, Armonk, NY (US)

(21) Appl. No.: 13/754,479

(22) Filed: Jan. 30, 2013

(51) Int. Cl. G06F 3/0482

(52) U.S. Cl. CPC G06F 3/0482
USPC 715/810

(57) ABSTRACT

A method includes, a computer generating a first listing of participants, the computer obtaining a second listing of known participants; and the computer generates a third listing of participants by only listing said second listing of known participants that appear in said first listing of participants.

### BACKGROUND

The present invention relates to generating a participants list, and more specifically, to generating a modified participants list based known participants.

With reference to FIG. 1, when users attend an electronic gathering of participants they are presented with a listing of participants 100. It is often that these electronic gathering can number in the hundreds. The only way to figure out who amongst the participants is someone a user knows is to scroll through the list trying to find names they recognize.

### SUMMARY

According to one aspect of the present invention, a method includes, a computer generating a first listing of participants, the computer obtaining a second listing of known participants, and the computer generates a third listing of participants by only listing the second listing of known participants that appear in the first listing of participants.

According to another aspect of the present invention, a method includes, a computer generating a first listing of participants, the computer obtaining a second listing of known participants, and the computer modifies the first listing of participants by identifying those participants that are also listed on the second listing of known participants.

According to still another aspect of the present invention, a computer system includes, one or more processors, one or more computer-readable memories and one or more computer-readable, tangible storage devices; a first module operatively coupled to at least one of the one or more storage devices for execution by at least one of the one or more processors via at least one of the one or more memories, configured to obtain and display a listing of participants, a second module coupled to at least one of the one or more storage devices for execution by at least one of the one or more processors via at least one of the one or more memories, configured to obtain a listing of known participants, a comparison module operatively coupled to at least one of the one or more storage devices for execution by at least one of the one or more processors via at least one of the one or more memories, configured to compare the listing of participants to the listing of known participants, and a modification module operatively coupled to at least one of the one or more storage devices for execution by at least one of the one or more processors via at least one of the one or more memories, configured to modify the listing of participants with known icons as a result of the comparison.

According to yet another aspect of the present invention, a computer program product including, one or more computer-readable, tangible storage medium; program instructions, stored on at least one of the one or more storage medium, to obtain and display a listing of participants, program instructions, stored on at least one of the one or more storage medium, to obtain a listing of known participants, program instructions, stored on at least one of the one or more storage medium, to compare the listing of participants to the listing of known participants, and program instructions, stored on at least one of the one or more storage medium, to modify the listing of participants with known icons as a result of the comparison.

### BRIEF DESCRIPTION OF THE SEVERAL VIEWS OF THE DRAWINGS

FIG. 1 depicts a typical listing of participants.

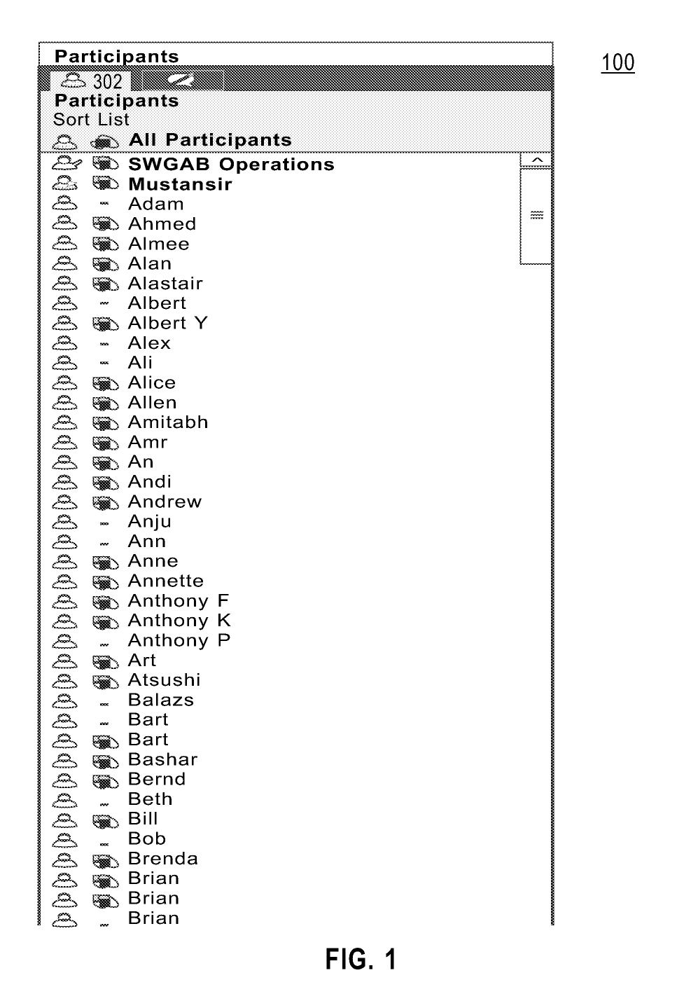

FIG. 2A illustrates a process for modifying a listing of participants according to an embodiment of the present invention.

FIG. 2B illustrates a process for creating a new list of participants according to an embodiment of the present invention.

FIG. 3 depicts an exemplary implementation according to an embodiment of the present invention.

FIG. 4 depicts an exemplary implementation according to an embodiment of the present invention.

FIG. 5 illustrates a hardware configuration according to an embodiment of the present invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. As will be appreciated by one skilled in the art, aspects of the present invention may be embodied as a system, method or computer program product.

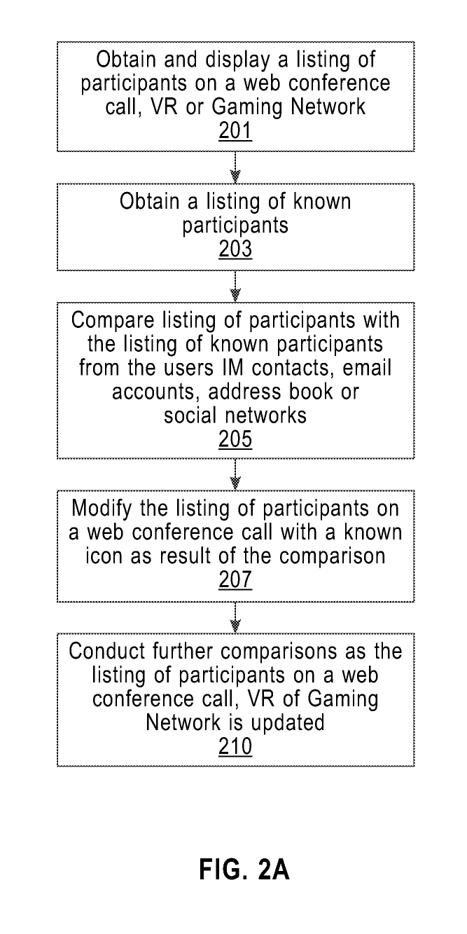

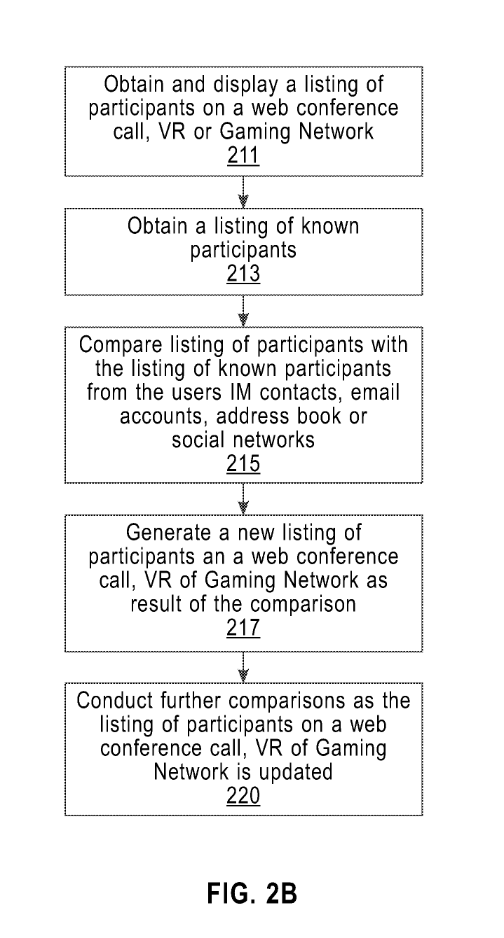

Now with reference to FIG. 2A, shown is a process for modifying a listing of participants according to an embodiment of the present invention. The process starts by obtaining and displaying a listing of participants (201) to a user. All of participants may be attending a web conference call, visiting a virtual reality world or taking part in a gaming network. The process continues by obtaining a listing of known participates (203) to a user. The listing of known participants can come from a user's instant messaging (IM) contacts, address book, social network connections or from common connections in various forums. The listing of participants and the known participants are compared to each other (205). One way a comparison can be done is by name or meta data. A best guess might be necessary in certain situations. Ex. Bob W Smith is likely the same as Bob William Smith. Another way a comparison can be done is by email address. Email address, when available, is an effective way to uniquely identify a person. Still another way comparison could be done is by phone number or address, if available.

Still referring to FIG. 2A, as a results of the comparison process the listing of participants list is modified with a known icon (207) when the user's known participants are attending the same web conference call, visiting the same virtual reality world or taking part in the same gaming network. The above comparison process is repeated in real time as the listing of participants on a web conference call, visiting a virtual reality world or taking part in a gaming network is updated (210).

With reference to FIG. 2B, shown is a process for modifying a listing of participants according to another embodiment of the present invention. The process starts by obtaining and displaying a listing of participants (211) to a user. All of participants may be attending a web conference call, visiting a virtual reality world or taking part in a gaming network. The process continues by obtaining a listing of known participates (213) to a user. The listing of known participants can come from a user's instant messaging (IM) contacts, address book, social network connections or from common connections in various forums. The listing of participants and the known participants are compared to each other (215). One way a comparison can be done is by name or meta data. A best guess might be necessary in certain situations. Ex. Bob W Smith is likely the same as Bob William Smith. Another way a comparison can be done is by email address. Email address, when available, is an effective way to uniquely identify a person. Still another way comparison could be done is by phone number or address, if available.

Still referring to FIG. 2B, as a results of the comparison process a new listing of the known participants list is generated in a separate window (217) when the user's known participants are attending the same web conference call, visiting the same virtual reality world or taking part in the same gaming network. The above comparison process is repeated in real time as the listing of participants on a web conference call, visiting a virtual reality world or taking part in a gaming network is updated (220).

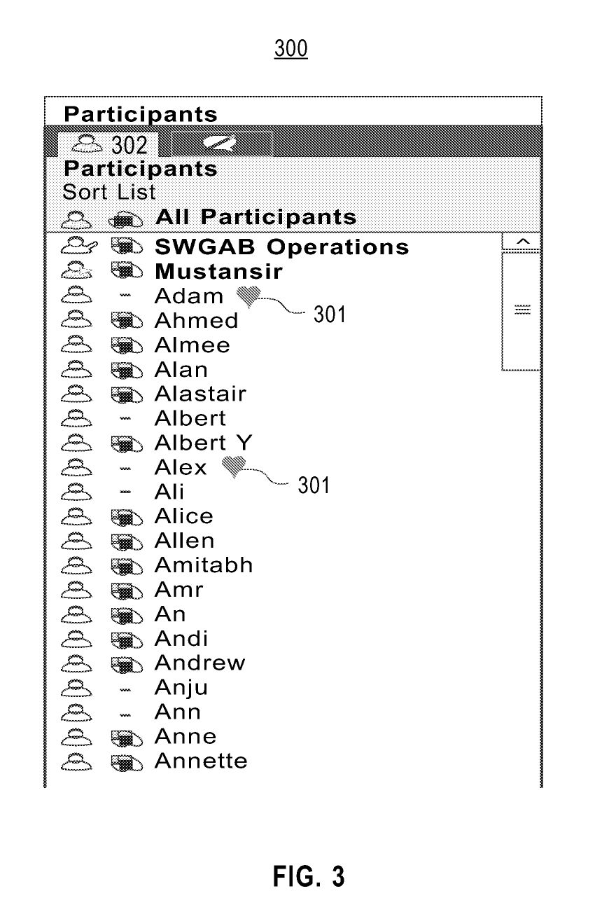

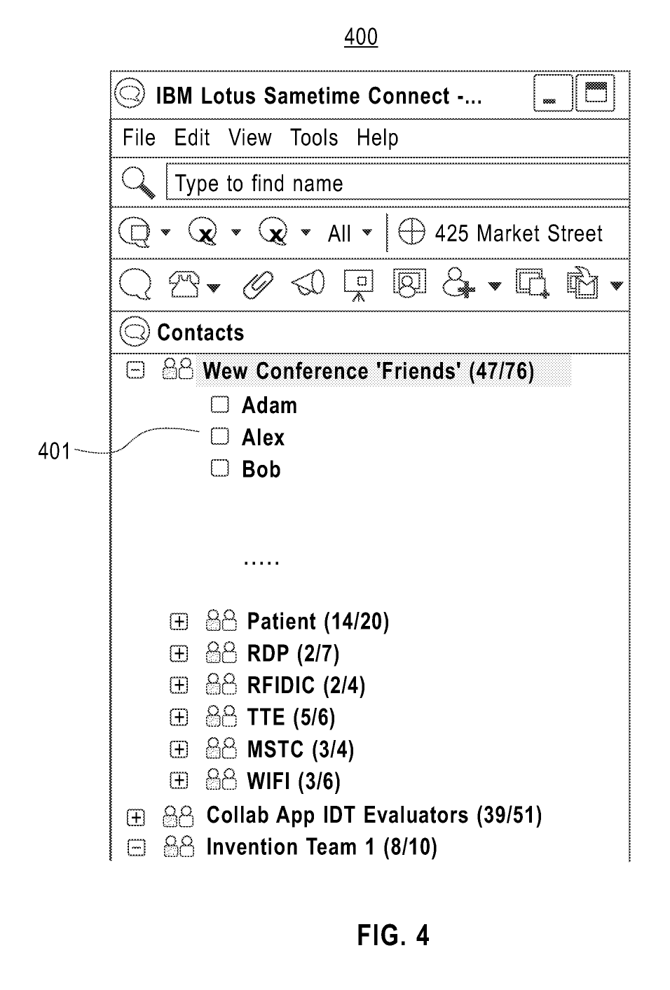

Referring to FIGS. 3 and 4, depicted are two exemplary implementations for the embodiments of the present invention. A listing of participants 300 is modified with a known icon 301 when the user's known participants are attending the same web conference call, visiting the virtual reality world or taking part in the same gaming network. An alternative implementation is to create a new window 400 which displays a listing of the known participants 401 when the user's known participants are attending the same web conference call, visiting the same virtual reality world or taking part in the same gaming network.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

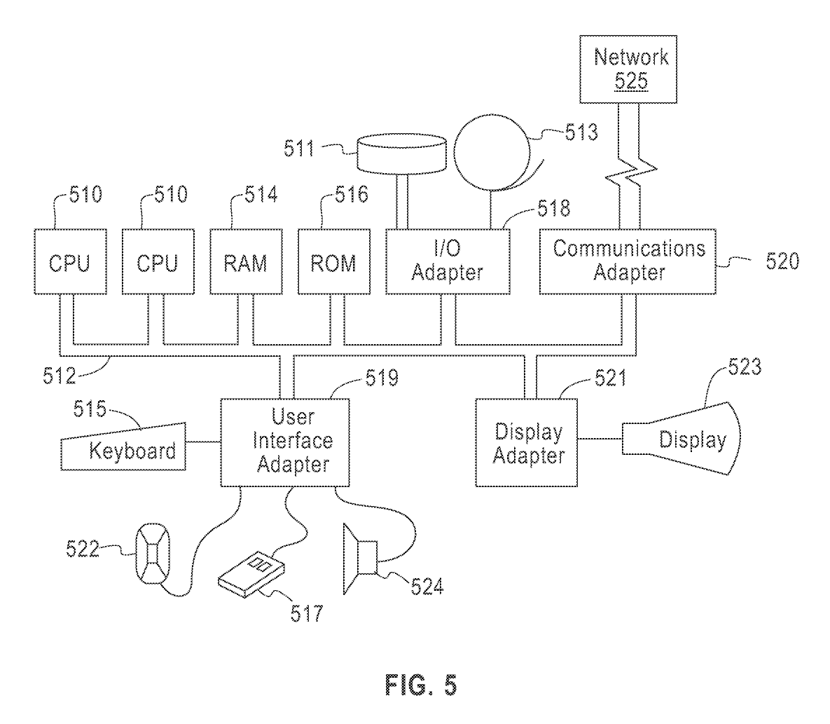

Referring now to FIG. 5, this schematic drawing illustrates a hardware configuration of an information handling/computer system in accordance with the embodiments of the invention. The system comprises at least one processor or central processing unit (CPU) 510. The CPUs 510 are interconnected via system bus 512 to various devices such as a random access memory (RAM) 514, read-only memory (ROM) 516, and an input/output (I/O) adapter 518. The I/O adapter 518 can connect to peripheral devices, such as disk units 511 and tape drives 513, or other program storage devices that are readable by the system. The system can read the inventive instructions on the program storage devices and follow these instructions to execute the methodology of the embodiments of the invention. The system further includes a user interface adapter 519 that connects a keyboard 515, mouse 517, speaker 524, microphone 522, and/or other user interface devices such as a touch screen device (not shown) to the bus 512 to gather user input. Additionally, a communication adapter 520 connects the bus 512 to a data processing network 525, and a display adapter 521 connects the bus 512 to a display device 523 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
a computer generating a first listing of participants;
the computer obtaining a second listing of known participants; and
the computer generates a third listing of participants by only listing said second listing of known participants that appear in said first listing of participants.

2. A method comprising:
a computer generating a first listing of participants;
the computer obtaining a second listing of known participants; and
the computer modifies said first listing of participants by identifying those participants that are also listed on said second listing of known participants.

3. The method according to claim 2, wherein said listing of participants are members attending a web conference call.

4. The method according to claim 2, wherein said second listing of known participants are members listed in a user's contacts listing.

5. The method according to claim 4, wherein said user's contacts listing are IM contacts.

6. The method according to claim 2, wherein said listing of participants are members participating in a virtual reality world.

7. The method according to claim 2, wherein said listing of participants are members participating in a gaming platform.

8. The method according to claim 4, wherein said user's contacts listing are contacts listed in the user's address book.

9. The method according to claim 4, wherein said user's contacts listing are contacts from a social network.

10. A computer system comprising:
one or more processors, one or more computer-readable memories and one or more computer-readable, tangible storage devices;
a first module operatively coupled to at least one of the one or more storage devices for execution by at least one of the one or more processors via at least one of the one or more memories, configured to obtain and display a listing of participants,
a second module coupled to at least one of the one or more storage devices for execution by at least one of the one or more processors via at least one of the one or more memories, configured to obtain a listing of known participants,
a comparison module operatively coupled to at least one of the one or more storage devices for execution by at least one of the one or more processors via at least one of the one or more memories, configured to compare the listing of participants to the listing of known participants, and
a modification module operatively coupled to at least one of the one or more storage devices for execution by at least one of the one or more processors via at least one of the one or more memories, configured to modify the listing of participants with known icons as a result of said comparison.

11. The system according to claim 10, wherein said listing of participants are members attending a web conference call.

12. The system according to claim 10, wherein said listing of known participants are members listed in a user's contacts listing.

13. The system according to claim 12, wherein said user's contacts listing are IM contacts.

14. The system according to claim 10, wherein said listing of participants are members participating in a virtual reality world.

15. The system according to claim 10, wherein said listing of participants are members participating in a gaming platform.

16. The system according to claim 12, wherein said user's contacts listing are contacts listed in the user's address book.

17. The system according to claim 12, wherein said user's contacts listing are contacts from a social network.

18. A computer program product comprising:
one or more computer-readable, tangible storage medium;
program instructions, stored on at least one of the one or more storage medium, to obtain and display a listing of participants,
program instructions, stored on at least one of the one or more storage medium, to obtain a listing of known participants,
program instructions, stored on at least one of the one or more storage medium, to compare the listing of participants to the listing of known participants, and
program instructions, stored on at least one of the one or more storage medium, to modify the listing of participants with known icons as a result of said comparison.

19. The computer program product according to claim 18, wherein said listing of participants are members attending a web conference call.

20. The computer program product according to claim 18, wherein said listing of known participants are members listed in a user's contacts listing.

21. The computer program product according to claim 20, wherein said user's contacts listing are IM contacts.

22. The computer program product according to claim 18, wherein said listing of participants are members participating in a virtual reality world.

23. The computer program product according to claim 18, wherein said listing of participants are members participating in a gaming platform.

24. The computer program product according to claim 20, wherein said user's contacts listing are contacts listed in the user's address book.

25. The computer program product according to claim 20, wherein said user's contacts listing are contacts from a social network.
